(19) United States
(12) Patent Application Publication
(10) Pub. No.: US 2010/0224140 A1
(43) Pub. Date: Sep. 9, 2010

(54) Method and a System for Measuring an Animal's Height

(75) Inventors: Tal Bareket, Kiryat Tivon (IL); Noam Pinski, Kineret-Moshava (IL)

Correspondence Address: MARTIN D. MOYNIHAN d/b/a PRTSI, INC., P.O. BOX 16446, ARLINGTON, VA, 22215, US

(73) Assignee: S.A.E. AFIKIM - COMPUTERIZED DAIRY MANAGEMENT SYST, Afikim (IL)

(21) Appl. No.: 12/225,348

(22) PCT Filed: Mar. 19, 2007
(86) PCT No.: PCT/IL2007/000353

§ 371 Date: Nov. 5, 2008

(30) Foreign Application Priority Data
Mar. 21, 2006 (IL) 174448

(51) Int. Cl. A01K 29/00; G06K 9/00

(52) U.S. Cl. 119/841; 382/110

(57) ABSTRACT

A method and a system for measuring animal's height is disclosed. The method, and the system as well, is comprised of the following steps: allowing the animal to pass through a passage with measurement-references; capturing plurality of images of the animal while the animal is passing; on each image of the captured images applying the following steps: filtering the background from the image; applying imaging-process technique on the lower area of the measuring-image to recognize the location of the legs; defining a vertical slice of the measuring-image, in which the back's contour of the animal—from neck to tail—appears and applying imaging processing and mathematical calculations to obtain the real height, as defined, of the animal.

### FIELD OF THE INVENTION

The present invention relates to the field of a dairy management. More specifically, the present invention relates to a method and a system for measuring animal's height particularly for ruminants.

### BACKGROUND OF THE INVENTION

The present invention relates generally to a novel system and method for obtaining the height dimension of animals.

In the domestic livestock industry it is advantageous to determine various different measurements of animals and height is an important one. For example, the growth rate of the heifer, which can be defined as heifer's height, is very helpful for estimating its' production as a mature cow.

Various systems for obtaining animal's dimensions and/or height are known. Unfortunately, these systems have various shortcomings that make these systems complicated and/or expensive. U.S. Pat. No. 6,625,302 to Kalscheur, et al. “System and method for obtaining animal and carcass measurements” uses infrared imagery and at least three fiducial reference points. U.S. Pat. No. 6,377,353 to Ellis “Three-dimensional measuring system for animals using structured light” uses a plurality of structured light elements and U.S. Pat. No. 5,412,420 to Ellis “Three-dimensional phenotypic measuring system for animals” uses a plurality of laser light signals.

However, the present invention provides a simple method and system for obtaining animals height.

### SUMMARY OF THE INVENTION

The present invention is a method and a system for measuring an animal's height.

According to the teachings of the present invention there is provided a method for measuring animal's height that is comprised of the following steps:
allowing the animal to pass through a narrow passage, wherein measurement-references are located in this passage;
capturing plurality of images or video images of the animal while the animal is passing through the passage;
on each image of the captured images or on each video frame or each of video selected frames applying the following steps:
   filtering the background from the image in order to obtain a measuring-image that contains the animals image and the measurement-reference solely;
   applying imaging-process technique on the lower area of the measuring-image to recognize the location of the rear and the front legs of the animal in the measuring-image;
   defining a vertical slice of the measuring-image, in which the back's contour of the animal—from neck to tail—appears. The definition can be done by using the locations of the rear and front legs;
   applying edge detecting to mark the animal's upper contour line in the vertical slice;
   calculating the height of each pixel or each sampled pixels of the marked line. Calculation is done according to the measurement-reference and then converting the height into a real height; and
   defining animal's real height by calculating one of the following:
      the average of the calculated real heights;
      the maximal real height of the calculated real heights; or
      the median of the calculated real heights; and
using the animal's real heights that were calculated from the plurality of image to calculate the animal's height. The animal's height is calculated as one of the followings:
   the average of the animal's real heights;
   the maximal real height of the animal's real heights; or
   the median of the animal's real heights.

According to a preferred embodiment, the method is used wherein the vertical slice is the narrowest slice, in which the rear legs or the front legs of the animal are appear. The slice in which the rear legs are appear enables locating the hip of the animal and measuring the height of the hip, which can defined as animal's height and the slice in which the front legs are appear enables to locate the animal's withers and measuring the height at this point.

According to another preferred embodiment, the method is used wherein the distance between the hip and the withers is measured and enables weighting height results.

According to a preferred embodiment, the method is further includes the following step, before calculating:
measuring, according to the measurement-references, at least one of the following:
a) the angle between each two legs of the animal;
b) the hoofs distance of each two legs of the animal;
c) the inclination of each animal's leg; and/or
d) the leg's folding angle of each animal's leg; and
analyzing the measurements in order to decide if the image should be ignored in the following steps or the information that were obtained from the image should be weight before use.

According to another preferred embodiment, the method is used wherein the passage has a homogenous color background.

According to a preferred embodiment, the method is further includes the step—after filtering the background:
converting the measuring-image into a binary image, preferably black and white image.

According to another aspect of the present invention a method is provided for measuring an animal's height. The method comprised of the following steps:
allowing the animal to pass through a narrow passage, wherein measurement-references are located in this passage;
capturing plurality of images of the animal while the animal is passing through this passage;
selecting one image from the plurality of image;
filtering the background from the selected-image in order to obtain a measuring-image that contains the animal's image and the measurement-reference solely;
applying imaging-process technique on the measuring-image to split a narrowest vertical slice, a rear-legs-slice in which the rear legs of the animal are appear or a front-legs-slice in which the front legs of the animal are appear or both slices;
calculating the real height of the heights pixel of the animals image in the narrowest vertical slice, according to the measurement-reference, using the rear-legs-slice for calculating hip height or using the front-legs-slice for calculating withers height or both; and
providing the real height as an animal's hip height, an animal's withers height or both.

According to another preferred embodiment, the method is used wherein the distance between the hip and the withers is measured and enables weighting height results.

According to another preferred embodiment, the method is used wherein the passage has a homogenous color background.

According to another preferred embodiment, the method is used wherein the selection is done by applying imaging-process technique for selecting an image from the plurality captured images, in order to select an image in which the animal legs are together.

According to another preferred embodiment the method further includes the step—after filtering the background:
converting the measuring-image into a binary image, preferably black and white image.

According to another preferred embodiment, the method is used wherein the capturing is done by a video camera, a still camera or any other image capturing means.

According to another aspect of the present invention, it is provided a system for measuring height of an animal, the system comprising of:
i) a narrow passage, enables an animal to pass through;
ii) measurement-references locating in the passage;
iii) an image capturing means for capture a plurality of animal's images while the animal is passing through the passage;
iv) a memory for storing the images and other information; and
v) a controller operative for:
   receiving the plurality of images from the capturing means;
   applying the following steps on each image of the plurality of images:
      filtering the background from the image in order to obtain a measuring-image that contains the animals image and the measurement-reference solely;
      applying imaging-process technique on the lower area of the measuring-image to recognize the location of the rear and the front legs of the animal in the measuring-image;
      defining a vertical slice of the measuring-image, in which the back's contour of the animal—from neck to tail—appears wherein the definition is done by using the locations of the rear and front legs;
      applying edge detecting to mark the contour line in the vertical slice;
      calculating the height of each pixel or sampled pixels of the marked line, according to the measurement-reference and converting the height into a real height; and
      defining animal's real height by calculating one of the followings:
         the average of the calculated real heights;
         the maximal real height of the calculated real heights; or
         the median of the calculated real heights;
   using the animal's real heights—of the plurality of image—to calculate the animal's height, wherein the animal's height is one of the following calculations:
      the average of the animal's real heights;
      the maximal real height, of the animal's real heights; or
      the median of the animal's real heights; and
   storing the animal's height in the memory.

According to a preferred embodiment the system is provided wherein the vertical slice is the narrowest slice, in which the rear legs or the front legs of the animal are appear and wherein the slice in which the rear legs are appear enables locating animal's hip and measuring the height of the hip and the slice in which the front legs are appear enables locating animal's withers and measuring the height of the withers.

According to another preferred embodiment the system is provided wherein the controller is further operative for the following, before calculating:
measuring, according to the measurement-references, at least one of the following:
a) the angle between each two legs of the animal;
b) the hoofs distance of each two legs of the animal;
c) the inclination of each animal's leg; and/or
d) the leg's folding angle of each animal's leg; and
analyzes the measurements, according to a predetermined criteria, in order to decide if the image should be ignored in the follow process or the information that were obtained from the image should be weight before use.

According to another preferred embodiment the system is provided wherein the narrow passage has a homogenous color background.

According to another preferred embodiment the system further includes animal's identification means and wherein the controller is further operative for receiving and storing the identification in the memory with the animal's height information.

According to another preferred embodiment the system is provided, wherein the controller is farther operative, after filtering the background, for:
converting the measuring-image into a binary image, preferably black and white image.

According to another preferred embodiment the system is provided, wherein the controller is farther operative for:
measuring the distance between the animal's hip and the animal's withers and uses the distance for weight height calculations.

According to another preferred embodiment the system is provided, wherein the capturing means is a video camera, a still camera or any other image capturing means.

According to another preferred embodiment the system is provided, wherein the controller is operative for:
receiving plurality of images from the capturing means;
selecting one image from the plurality of image;
filtering the background from the selected-image in order to obtain a measuring-image that contains the animals image and the measurement-reference solely;
applying imaging-process technique on the measuring-image to split a narrowest vertical slice, a rear-legs-slice in which the rear legs of the animal are appear or a front-legs-slice in which the front legs of the animal are appear or both slices;
calculating the real height of the heights pixel of the animals image in the narrowest vertical slice, according to the measurement-reference, using the rear-legs-slice for calculating hip height or using the front-legs-slice for calculating withers height or both; and
storing the calculated real height as an animal's height in the memory.

According to another preferred embodiment the system is provided, wherein the controller is further operative for calculating the distance between the hip and the withers and stores the calculation in the memory, to enable weighting height results;

According to another preferred embodiment the system is provided, wherein the selection is done by applying imaging-process technique for selecting an image from the plurality captured images, in order to select an image in which the animal legs are together.

According to another preferred embodiment the system further includes animal's identification means and wherein the controller is further operative for receiving and storing the identification in the memory with the animal's height information.

According to another preferred embodiment the system is provided, wherein the controller is farther operative, after filtering the background, for:
converting the measuring-image into a binary image, preferably black and white image.

According to another preferred embodiment the system is provided wherein the capturing means is a video camera, a still camera or any other image capturing means.

### BRIEF DESCRIPTION OF THE FIGURES

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

In the figures:

FIG. 1 illustrates an embodiment of the system according to the present invention.

FIG. 2 illustrates the measuring method by way of processing wide slice and plurality of images.

FIG. 3 illustrates the measuring method by way of processing narrow slice of a selected image.

### DESCRIPTION OF THE PREFERRED EMBODIMENTS

The present invention is a method for measuring an animal's height. The method based on a processing of images that are captured while the animal passes through a narrow passage. The animal's height is deduced either from an image processing of plurality of images or from an image processing of a selected image.

The principles and operation of the method and the system for measuring animal's height according to the present invention may be better understood with reference to the drawing and the accompanying description.

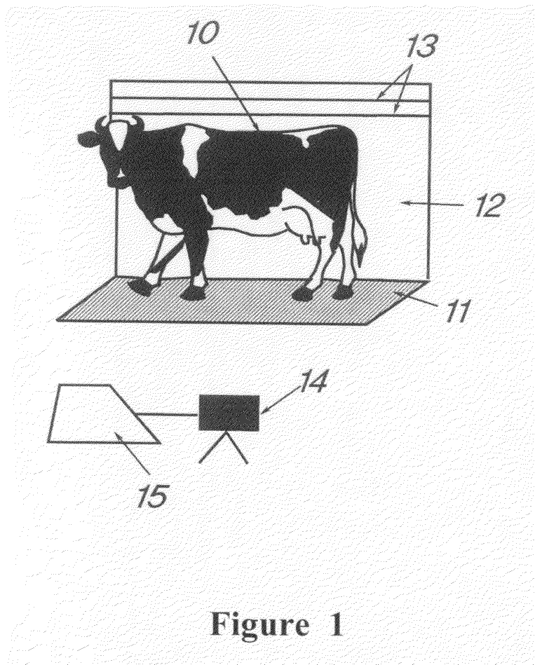

Referring now to the drawing, FIG. 1 illustrates an embodiment of the system according to the present invention. The animal 10 is leaded to pass through a narrow passage 11, preferably with a homogenous color background 12 and while the animal is passing an imaging device 14 captures plurality of images that are transferred to a computing unit 15. The computing unit 15 uses the method that will be described in the next figures to calculate the height of the passing animal 10.

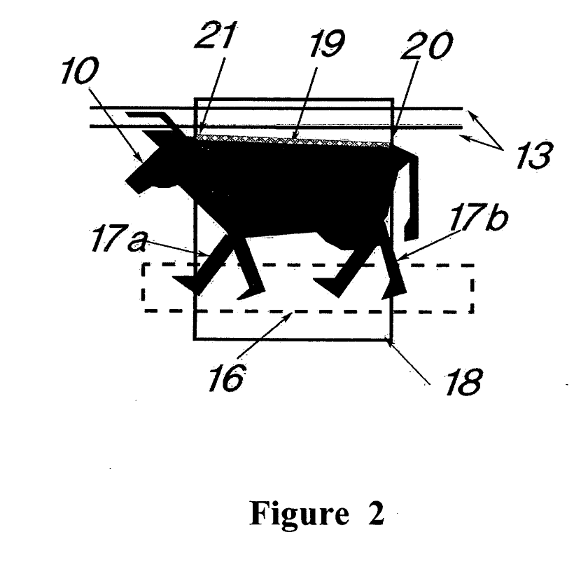

FIG. 2 illustrates the measuring method by way of processing wide slice and plurality of images. The process is done by the computing unit 15 using image processing techniques and mathematical calculations. In the first stage each image of the captured images is filtered in order to obtain a measuring-image that contains the animals image 10 and the measurement-reference 13—in this case two lines with known location. An image processing technique is applied on the lower area 16 of each image to recognize the location of the rear legs 17b and the front legs 17a of the animal in the measuring-image. Defining in each measuring-image a vertical slice 18 in the measuring-image, in which the back's contour 19 of the animal 10—from withers (or neck) 21 to the hip (or tail)—appears. Using the locations of the rear legs 17b and the front legs 17a can do this definition. Applying edge detection to mark the animal's contour line 19 in each measuring-image, according to the measurement-reference 13 calculating the height of each pixel or sampled pixels of the marked line 19 and converting the heights into real heights.

In the second stage, the animal's real height is calculated according to each measuring-image. The animal's real height can be defined as the average of the calculated real heights or the maximal real height of the calculated real heights or the median of the calculated real heights.

The animal's real heights that obtained from the whole measuring-images are used to calculate the animal's height. Animal's height can be defined as the average of the animal's real heights of the whole measuring-images or the maximal real height that calculated from the whole measuring-images or the median of the animal's real heights.

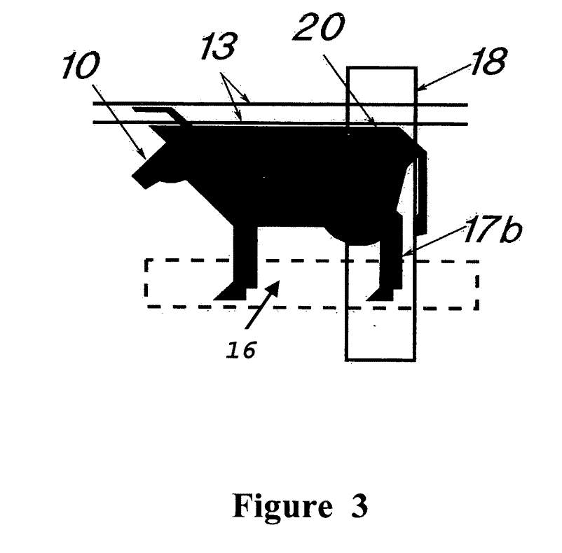

FIG. 3 illustrates the measuring method by way of processing narrow slice of a selected image. The first stage in the illustrated embodiment is to select an image from the plurality captured images. In this embodiment the animal's 10 height is defined as the animal's hip 20 height, therefore the selected image is an image in which the animal's rear legs 17b are together—the position in which animal's hip 20 is in the maximal rise. To find the rear legs 17b location and position, an image processing is used in the image's low area 16.

In the second stage the selected image is filtered in order to obtain a measuring-image that contains the animals image 10 and the measurement-reference 13—in this case two lines with known location. A vertical slice 18 is defined, which is the narrowest slice that contains the rear lags 17b. Applying edge detection to detect the hip's 20 contour and height of each pixel or sampled pixels is calculated, according to the measurement-reference 13. The pixels heights are converted to real heights.

The animal's height can be defined as the average of the pixels heights or the height of the heights pixel or the median of the pixels' heights.

Although the invention has been described in conjunction with specific embodiments thereof, it is evident that many alternatives, modifications and variations will be apparent to those skilled in the art, accordingly, it is intended to embrace all such alternatives, modifications and variations that fall within the spirit and broad scope of the appended claims.

What is claimed is:

1. A method for measuring an animal's height comprising of the following steps:
allowing said animal to pass through a narrow passage, wherein measurement-references are located in said passage;
capturing plurality of images of said animal while said animal is passing through said passage;
applying the following steps on each image of said plurality of images:
filtering the background from said image in order to obtain a measuring-image that contains said animals image and said measurement-reference solely;
applying imaging-process technique on the lower area of said measuring-image to recognize the location of the rear and the front legs of said animal in said measuring-image;
defining, by using said locations of said rear and front legs, a vertical slice of said measuring-image, in which the back's contour of said animal appears, wherein said contour is the high contour of said animal's back from the neck to the tail of said animal;
applying edge detecting to mark said contour line in said vertical slice;
calculating the height of each pixel or sampled pixels of said marked line, according to said measurement-reference and converting said height into a real height; and
defining animal's real height by calculating one of the following:
the average of said calculated real heights;
the maximal real height of said calculated real heights; or
the median of said calculated real heights; and
using said animal's real heights—of said plurality of image—to calculate said animal's height, wherein said animal's height is calculated as one of the followings:
the average of said animal's real heights;
the maximal real height of said animal's real heights; or
the median of said animal's real heights.

2. The method of claim 1, wherein said vertical slice is the narrowest slice, in which the rear legs or the front legs of said animal are appear and wherein the slice in which the rear legs are appear enables locating animal's hip and is used for measuring the height of said hip and the slice in which the front legs are appear enables locating animal's shoulder and is used for measuring the height of said withers.

3. The method of claim 2, wherein the distance between said hip and said withers is measured and enables weighting the calculated height results according to known parameters.

4. The method of claim 1, further includes the following step, before calculating:
measuring, according to said measurement-references, at least one of the following:
a) the angle between each two legs of said animal;
b) the hoofs distance of each two legs of said animal;
c) the inclination of each animal's leg; and/or
d) the leg's folding angle of each animal's leg; and
analyzing said measurements in order to decide if said image should be ignored in the following steps or the information that were obtained from said image should be weight before use.

5. The method of claim 1, wherein said passage has a homogenous color background.

6. The method of claim 1, further includes the step—after filtering the background:
converting said measuring-image into a binary image, preferably black and white image.

7. The method of claim 1, wherein said capturing is done by a video camera, a still camera or any other image capturing means.

8. A method for measuring an animal's height, said method comprised of the following steps:
allowing said animal to pass through a narrow passage, wherein measurement-references are located in said passage;
capturing plurality of images of said animal while said animal is passing through said passage;
selecting one image from said plurality of image;
filtering the background from said selected-image in order to obtain a measuring-image that contains said animal's image and said measurement-reference solely;
applying imaging-process technique on said measuring-image to split a narrowest vertical slice, a rear-legs-slice in which the rear legs of said animal are appear or a front-legs-slice in which the front legs of said animal are appear or both slices;
calculating the real height of the heights pixel of said animals image in said narrowest vertical slice, according to said measurement-reference, using said rear-legs-slice for calculating hip height or using said front-legs-slice for calculating withers height or both; and
providing said real height as an animal's hip height, an animal's withers height or both.

9. The method of claim 8, wherein the distance between said hip and said withers is measured and enables weighting the calculated height results according to known parameters.

10. The method of claim 8, wherein said passage has a homogenous color background.

11. The method of claim 8, wherein said selection is done by applying imaging-process technique for selecting an image from said plurality captured images, in order to select an image in which said animal legs are together.

12. The method of claim 8 further includes the step—after filtering said background:
converting said measuring-image into a binary image, preferably black and white image.

13. The method of claim 8, wherein said capturing is done by a video camera, a still camera or any other image capturing means.

14. A system for measuring height of an animal, said system comprising of:
i) a narrow passage, enables an animal to pass through;
ii) measurement-references locating in said passage;
iii) an image capturing means for capture a plurality of animal's images while said animal is passing through said passage;
iv) a memory for storing said images and other information; and
v) a controller operative for:
receiving said plurality of images from said capturing means;
applying the following steps on each image of said plurality of images:
filtering the background from said image in order to obtain a measuring-image that contains said animals image and said measurement-reference solely;
applying imaging-process technique on the lower area of said measuring-image to recognize the location of the rear and the front legs of said animal in said measuring-image;
defining a vertical slice of said measuring-image, in which the back's contour of said animal—from neck to tail—appears wherein said definition is done by using said locations of said rear and front legs;
applying edge detecting to mark said contour line in said vertical slice;
calculating the height of each pixel or sampled pixels of said marked line, according to said measurement-reference and converting said height into a real height; and
defining animal's real height by calculating one of the followings:
the average of said calculated real heights;
the maximal real height of said calculated real heights; or
the median of said calculated real heights;
using said animal's real heights—of said plurality of image—to calculate said animal's height, wherein said animal's height is one of the following calculations:
the average of said animal's real heights;
the maximal real height, of said animal's real heights; or
the median of said animal's real heights; and
storing said animal's height in said memory.

15. The system of claim 14, wherein said vertical slice is the narrowest slice, in which the rear legs or the front legs of said animal are appear and wherein said slice in which the rear legs are appear enables locating animal's hip and measuring the height of said hip and said slice in which the front legs are appear enables locating animal's withers and measuring the height of said withers.

16. The system of claim 14, wherein said controller is further operative for the following, before calculating:
measuring, according to said measurement-references, at least one of the following:
a) the angle between each two legs of said animal;
b) the hoofs distance of each two legs of said animal;
c) the inclination of each animal's leg; and/or
d) the leg's folding angle of each animal's leg; and
analyzes said measurements, according to a predetermined criteria, in order to decide if said image should be ignored in the follow process or the information that were obtained from said image should be weight before use.

17. The system of claim 14, wherein said narrow passage has a homogenous color background.

18. The system of claim 14, further includes animal's identification means and wherein said controller is further operative for receiving and storing said identification in said memory with said animal's height information.

19. The system of claim 14, wherein said controller is farther operative, after filtering said background, for:
converting said measuring-image into a binary image, preferably black and white image.

20. The system of claim 14, wherein said controller is farther operative for:
measuring the distance between said animal's hip and said animal's withers and uses said distance for weight height calculations.

21. The system of claim 14, wherein said capturing means is a video camera, a still camera or any other image capturing means.

22. The system of claim 14, wherein said controller is operative for:
receiving plurality of images from said capturing means;
selecting one image from said plurality of image;
filtering the background from said selected-image in order to obtain a measuring-image that contains said animals image and said measurement-reference solely;
applying imaging-process technique on said measuring-image to split a narrowest vertical slice, a rear-legs-slice in which the rear legs of said animal are appear or a front-legs-slice in which the front legs of said animal are appear or both slices;
calculating the real height of the heights pixel of said animals image in said narrowest vertical slice, according to said measurement-reference, using said rear-legs-slice for calculating hip height or using said front-legs-slice for calculating withers height or both; and
storing said calculated real height as an animal's height in said memory.

23. The system of claim 22, wherein said controller is further operative for calculating the distance between said hip and said withers and stores said calculation in said memory, to enable weighting height results;

24. The system of claim 22, wherein said selection is done by applying imaging-process technique for selecting an image from said plurality captured images, in order to select an image in which said animal legs are together.

25. The system of claim 22, further includes animal's identification means and wherein said controller is further operative for receiving and storing said identification in said memory with said animal's height information.

26. The system of claim 22, wherein said controller is farther operative, after filtering said background, for:
converting said measuring-image into a binary image, preferably black and white image.

27. The system of claim 22, wherein said capturing means is a video camera, a still camera or any other image capturing means.
